(19) United States
(12) Patent Application Publication
(10) Pub. No.: US 2008/0270811 A1
(43) Pub. Date: Oct. 30, 2008

(54) Fast Suspend-Resume of Computer Motherboard Using Phase-Change Memory

(75) Inventors: David Q. Chow, San Jose, CA (US); Charles C. Lee, Cupertino, CA (US); Frank I-Kang Yu, Palo Alto, CA (US)

Correspondence Address: STUART T AUVINEN, 429 26TH AVENUE, SANTA CRUZ, CA, 95062-5319, US

(73) Assignee: SUPER TALENT ELECTRONICS INC., San Jose, CA (US)

(21) Appl. No.: 11/740,398

(22) Filed: Apr. 26, 2007

(51) Int. Cl. G06F 1/32; G06F 9/38

(52) U.S. Cl. 713/323; 712/205; 712/E09.045

(57) ABSTRACT

A personal computer motherboard has a main memory of phase-change-memory (PCM) chips in PCM memory modules. An operating system (OS) image is stored in the PCM memory modules and is retained during suspend since the PCM chips are non-volatile. The microprocessor can directly read the OS image retained in the PCM memory modules without copying an OS image from a hard disk to the main memory upon resume. Therefore a boot loader program in the boot ROM does not have to be fetched to the microprocessor for suspend/resume. The video memory can also be PCM, allowing the frame buffer to be retained during suspend/resume, yet be directly addressable by the microprocessor. The display is quickly activated since the frame buffer does not have to be re-constructed after suspend/resume. PCM cells use amorphous and crystalline states of a variable resistor to store data.

### FIELD OF THE INVENTION

This invention relates to personal computers, and more particularly to fast suspend/resume using phase-change memories.

### BACKGROUND OF THE INVENTION

Personal computers (PC's) are widely deployed in businesses and homes around the world. The most popular PC's have a microprocessor that is based on the x86 architecture and run an operating system such as Microsoft's Windows or Linux. Since the x86 architecture is quite old, booting procedures are less than optimal for more modem PC's.

One particular problem area has been in quickly resuming operation of the PC after suspending its operation. Ideally, such suspend/resume should be much faster than a full reboot of the PC, which can take several minutes. Unfortunately, the hardware technologies and PC software used inhibits fast suspend/resume.

FIG. 1A shows a prior-art PC. CPU 22 is a central processing unit such as an x86 microprocessor. SRAM cache 24 is an instruction and data cache that may be part of the same chip as CPU 22, or may be an external static random-access-memory (SRAM) cache. CPU 22 fetches data and instructions from dynamic-random-access memory (DRAM) memory modules 30, and caches these data and instructions in SRAM cache 24. These instructions may alter the image shown to the user on display 26 by writing video data to a frame buffer in video memory 32. Video memory 32 may be a separate dynamic-random-access memory (DRAM) or video RAM on a graphics card, or may be a portion of DRAM memory modules 30.

CPU 22 can directly address memory such as video RAM 32 and DRAM memory modules 30 that are on local bus 40. Other slower memories and peripherals are separated from local bus 40 by I/O coprocessor 28. I/O coprocessor 28 receives requests from CPU 22 on local bus 40 and translates these requests into bus cycles on peripheral buses 42, 43 that access peripherals. For example, flash memory 36 can be a flash drive that is plugged into a Universal-Serial-Bus (USB), while hard disk drive 34 is accessed over an integrated device electronics (IDE) or Serial AT-Attachment (SATA) bus.

Boot ROM 38 is a flash read-only memory (ROM) that contains the first instructions executed by CPU when power is applied, or after re-booting. I/O coprocessor 28 can be reset at power-up to connect CPU 22 to boot ROM 38, or a hardware state machine in I/O coprocessor 28 or elsewhere can copy the instructions from boot ROM 38 to DRAM memory modules 30 for execution by CPU 22. Boot ROM 38 could be placed directly on local bus 40, but the loading from boot ROM 38 may slow down local bus 40.

During the booting sequence, operating-system OS image 44′ is copied from hard disk drive 32 to DRAM memory modules 30 to form OS image 44 that CPU 22 can directly access. Since hard disk drive 32 is a mass storage device that stores data in sectors, OS image 44′ is only block-addressable, not randomly addressable. Thus OS image 44′ must be copied or reconstructed in DRAM memory modules 30 so that CPU 22 can directly address OS image 44.

In FIG. 1B, the PC is resuming after a suspend. When the PC is suspended, some key state information is quickly copied from DRAM memory modules 30 to hard disk drive 34. For example, OS image 44 is copied from DRAM memory modules 30 to hard disk drive 34 as OS image 44′. When power is removed from the PC during suspend, volatile memories lose their data. All data in DRAM memory modules 30, including OS image 44, are lost, and all data in SRAM cache 24 and video memory 32 are also lost, as shown by the dashed X's in FIG. 1B. Display 26 no longer displays the frame-buffer image in video memory 32 to the user.

When the PC resumes operation after suspend, and power is re-applied, DRAM memory modules 30, video memory 32, and SRAM cache 24 are all blank, or contain garbage data. Boot instructions in a resume routine are copied from boot ROM 38 to CPU 22 through I/O coprocessor 28. These boot instructions include a boot loader program that is executed by CPU 22 to copy more data into DRAM memory modules 30. For example, OS image 44′ is read from hard disk drive 34 and copied into DRAM memory modules 30 to recreate OS image 44. OS image 44 can then be executed by CPU 22, allowing the user to again run application programs on the PC.

The process of reading boot instructions from boot ROM 38, and copying OS image 44 from hard disk drive 34 to DRAM memory modules 30 is relatively slow, causing suspend/resume to be less than an instant-on experience. The size of OS image 44 can be quite large, especially for newer operating systems with many features and bloated code.

Non-volatile memories have been available for many years. Such non-volatile memories do not lose data when power is removed. For example, boot ROM 38 is a non-volatile memory such as NOR flash. However, non-volatile memory such as NAND flash memory tends to be used for mass storage devices rather than for randomly-addressable devices. Mass storage devices are complex to access since sectors of 512 or more bytes are read or written together as a block. Individual bytes cannot be accessed. Since CPU 22 may write individual bytes, or words of 64 or fewer bytes, the block-addressing of mass storage devices is undesirable. Complex direct-memory access (DMA) in hardware or software is often used. Relatively slow accesses and capacitive loading of buses further limit use of non-volatile memories and increase suspend/resume delays.

What is desired is a personal computer with fast suspend/resume operations. A PC motherboard that supports intrinsically rapid resume is desirable. An improved PC architecture is desired.

### BRIEF DESCRIPTION OF THE DRAWINGS

FIG. 1A shows a prior-art PC.

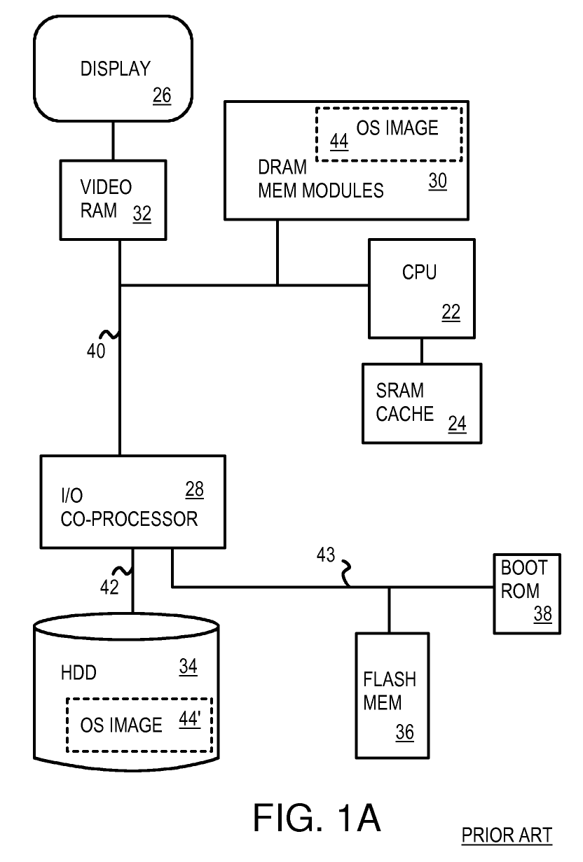

FIG. 1B shows the prior-art PC resuming after a suspend.

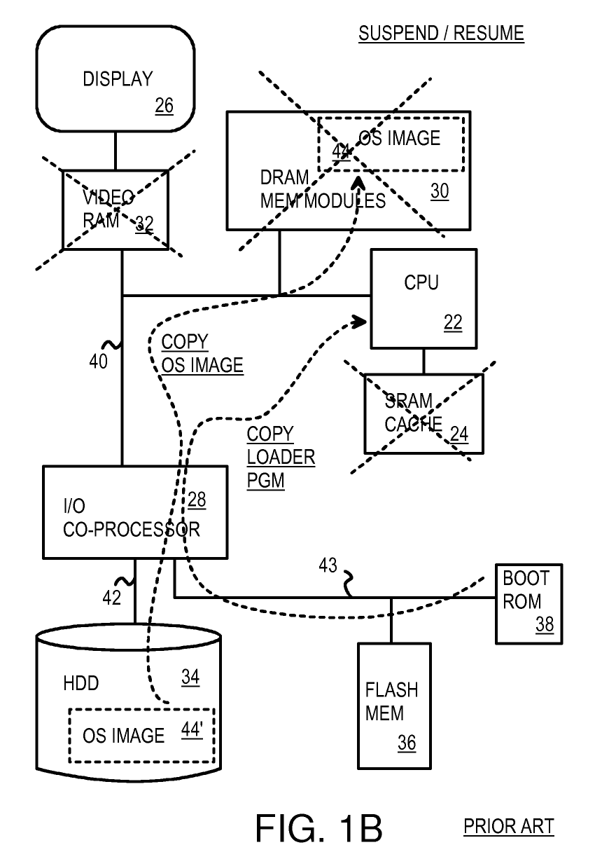

FIG. 2 shows a phase-change memory cell.

FIG. 3 is a graph of current and time to transform states in a phase-change memory cell.

FIG. 4 shows an array of phase-change memory cells.

FIG. 5 shows a fast suspend/resume personal computer using phase-change memory on the CPU's local bus.

FIG. 6 shows more details of a fast-resuming motherboard using phase-change memory.

FIG. 7 shows a phase-change memory.

FIG. 8 shows a phase-change memory module.

### DETAILED DESCRIPTION

The present invention relates to an improvement in personal computer motherboards. The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

The inventors have realized that suspend/resume performance in a PC is limited by the awkward copying of operating-system image information from a slow hard disk drive to the volatile main memory. If the main memory were non-volatile, then such OS image copying would not be needed, and suspend/resume performance can be improved.

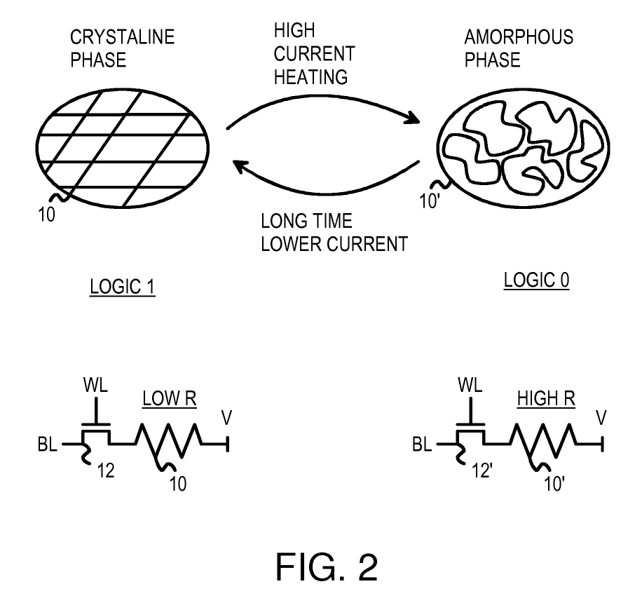

FIG. 2 shows a phase-change memory cell. Traditionally, flash memory has been used for non-volatile storage. Another kind of non-volatile memory, phase-change memories, were discovered in the 1960's, and were even written about in a paper in Electronics magazine in September 1970 by the founder of Intel Corp., Gordon Moore. However, despite the long-felt need for faster suspend/resume operations, this 40-year-old technology has not yet been applied to solve the suspend/resume problem that millions of PC's have.

Phase-change memory (PCM) uses a layer of chalcogenide glass that can be switched between a crystalline and an amorphous state. The chalcogenide glass layer can be an alloy of germanium (Ge), antimony (Sb), and tellurium (Te). This alloy has a high melting point, which produces the amorphous state when cooled from the melting point. However, when the solid alloy is heated from the amorphous state, the alloy transforms into a crystalline state at a crystallization temperature than is below its melting point. Such heating can be provided by an electric current through the alloy. The state change may occur rapidly, such as in as little as 5 nanoseconds.

In FIG. 2, when alloy resistor 10 is in the crystalline state, its resistivity is low. The crystalline state represents a logic high or 1. A PCM memory cell has alloy resistor 10 in series with select transistor 12 between a bit line BL and a voltage V. When V is a low voltage such as ground, and word line WL is driven high, the bit-line voltage is pulled from a high pre-charged state to ground through select transistor 12 and alloy resistor 10 due to the low resistance of alloy resistor 10.

When alloy resistor 10′ is in the amorphous state, its resistivity is high. The amorphous state represents a logic low or 0. Another PCM memory cell has alloy resistor 10′ in series with select transistor 12′ between a bit line BL and a voltage V. When V is a low voltage such as ground, and word line WL is driven high, the bit-line voltage remains in its high or pre-charged state, since the high resistance of alloy resistor 10′ limits current through select transistor 12′.

Note that the assignment of logical 0 and logic 1 states to the crystalline and amorphous states is arbitrary. The crystalline state could be assigned logical 1 or logical 0, with the amorphous state having the opposite logical value.

Alloy resistor 10 may be a small layer that is integrated with select transistor 12, such as a layer over or near the source terminal of transistor 12. Alternately, alloy resistor 10 may be a separate resistor device, such as a patterned line or snaking line between the source of select transistor 12 and ground.

When a high current is passed through alloy resistor 10, the alloy can transform from the crystalline state into the amorphous state. The high current creates resistive heating in alloy resistor 10 and the melting temperature is rapidly reached, causing the crystal to melt into a liquid. Upon rapid cooling, alloy resistor 10 solidifies into the amorphous state since there is little time for crystals to grow during cooling.

When a lower current is passed through alloy resistor 10 for a long period of time, the crystalline temperature is reached or exceeded. However, the current is not sufficient to cause the higher melting temperature to be reached. The amorphous alloy begins to crystallize over this long time period. For example, small crystal domains within the amorphous state may grow and absorb other domains until alloy resistor 10 contains one or just a few crystal domains.

Thus alloy resistor 10′ transforms from the high-resistance amorphous state into the low-resistance crystalline state by applying a moderate current for a relatively long period of time, allowing the crystal to grow at the crystalline temperature. Alloy resistor 10 transforms from the low-resistance crystalline state into the high-resistance amorphous state by applying a high current for a relatively short period of time, allowing the crystal to melt into an amorphous blob at the melting temperature.

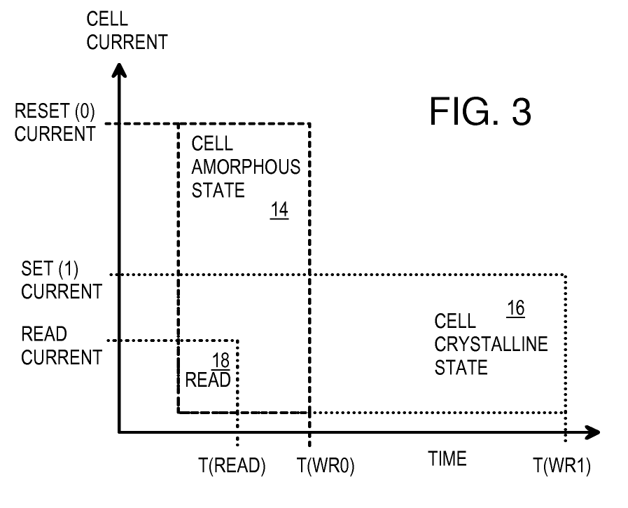

FIG. 3 is a graph of current and time to transform states in a phase-change memory cell. Amorphous state 14 is reached when a high current (the reset current) is applied for a time of T(WR0). Crystalline state 16 is reached when a moderate current, the set current, is applied for a longer period of time T(WR1). These states are retained when currents below the moderate current are applied, or when currents are applied for short periods of time. State transformations, or partial state transformations, may occur when the full currents and times are not both met, such as applying the set current for less than the set time. These partial state transformations are undesirable.

The PCM cell can safely be read by applying a lower read current for a short period of time. For example, the read current can be less than either the set or reset currents. Reading 18 has the read current applied for less than the set or reset times, T(WR1), T(WR0), respectively. For example, the read time T(READ) can be less than half of the reset time, and the read current can be less than half of the set current. The reset current can be double or more the set current, and the set time can be double, triple, 5×, or more of the reset time.

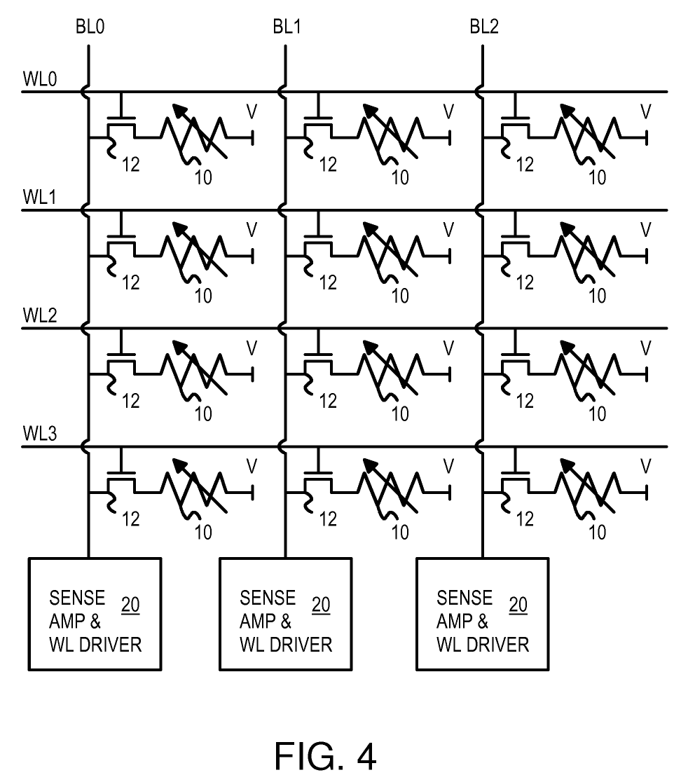

FIG. 4 shows an array of phase-change memory cells. Word lines WL0:3 are applied to the gates of select transistors 12, while bit lines BL0:2 connect to the drains of select transistors 12. Alloy resistors 10 are in series between the sources of select transistors 12 and a cell voltage V, which could be ground, power, or some other voltage, and could be switched on and off, such as for power down or to disable an array or block.

Alloy resistors 10 each can be in a high-resistance amorphous state, or in a low-resistance crystalline state. The current drawn from a bit line by select transistor 12 and alloy resistor 10 in the selected word line (row) is sensed by sense amplifiers 20 and amplified and buffered to generate the data read from the cell. The current drawn through alloy resistor 10 is less than or equal to the read current.

During writing, sense amplifiers 20 activate bit-line drivers that drive the set or reset current onto the bit lines and through the selected alloy resistor. After the current is applied for the set or reset time, alloy resistor 10 is transformed into the new state, either the amorphous or crystalline state. One cell per column is written, since only one of the word lines is activated at a time. Columns being written into the 0 state have the reset current applied to the bit line for the reset time period, while columns being written into the 1 state have the set current applied for the set time period.

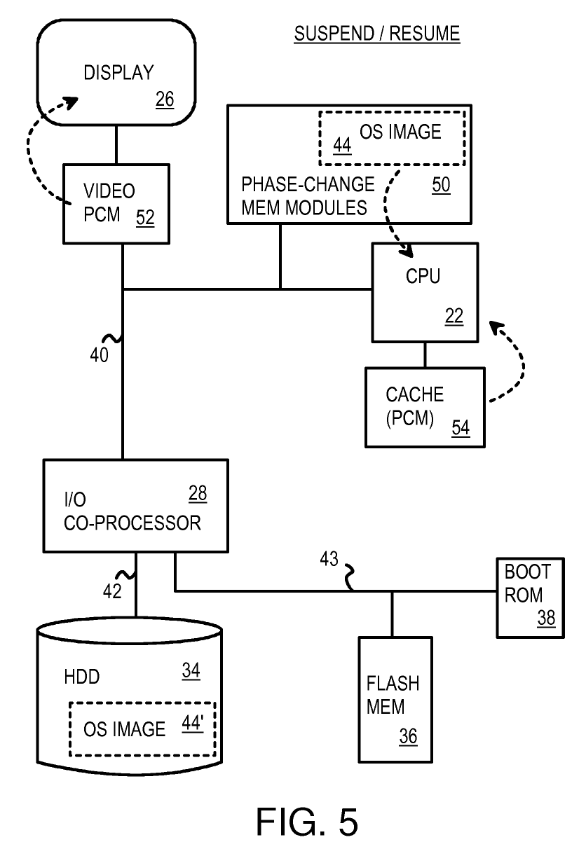

FIG. 5 shows a fast suspend/resume personal computer using phase-change memory on the CPU's local bus. CPU 22 reads instructions and data from PCM memory modules 50, which form the bulk of the CPU's main memory. PCM memory modules 50 contain phase-change memory cells, which are non-volatile. Video PCM memory 52 also uses phase-change memory. Cache 54 may be standard SRAM or may also use PCM. When cache 54 uses SRAM, the contents of cache 54 can be invalidated during suspend or resume routines so that the cache is reloaded from PCM memory modules after resume.

When a suspend occurs, OS image 44 may be copied to hard disk drive 34 as OS image 44′ for safety or for backwards compatibility purposes. However OS image 44 is retained in PCM memory modules 50 since phase-change memory is non-volatile. Thus there is no need to copy OS image 44′ from hard disk drive 34 upon resume. Instead, CPU 22 can resume execution of instructions and data from OS image 44 directly from PCM memory modules 50 without a lengthy copy of OS image 44′ from hard disk drive 34. Thus resume time is significantly reduced.

Video PCM memory 52 is also formed from phase-change memory, and thus retains the frame buffer when power is suspended. Upon resume, display 26 can resume display as pixels can be read from the frame buffer in video PCM memory 52 without having to be re-constructed and re-rendered. Thus significant time is saved by not re-generating the frame buffer, and display 26 can begin display to the user faster. The faster display resume time is especially noticeable to the user since it is visual.

I/O coprocessor 28 does not have to be configured during suspend to connect boot ROM 38 to CPU 22, further saving time. Since bus cycles through I/O coprocessor 28 are considerably slower than accesses on local bus 40, processing times for suspend/resume routines is further improved.

Since non-volatile phase-change memory is used on local bus 40, OS image 44′ does not have to be read and copied from hard disk drive 34, and the boot loader program does not have to be read from boot ROM 38. In some embodiments, phase-change memory may be used to replace the memory cells in boot ROM 38, flash memory 36, or as a sold-state disk that replaces hard disk drive 34.

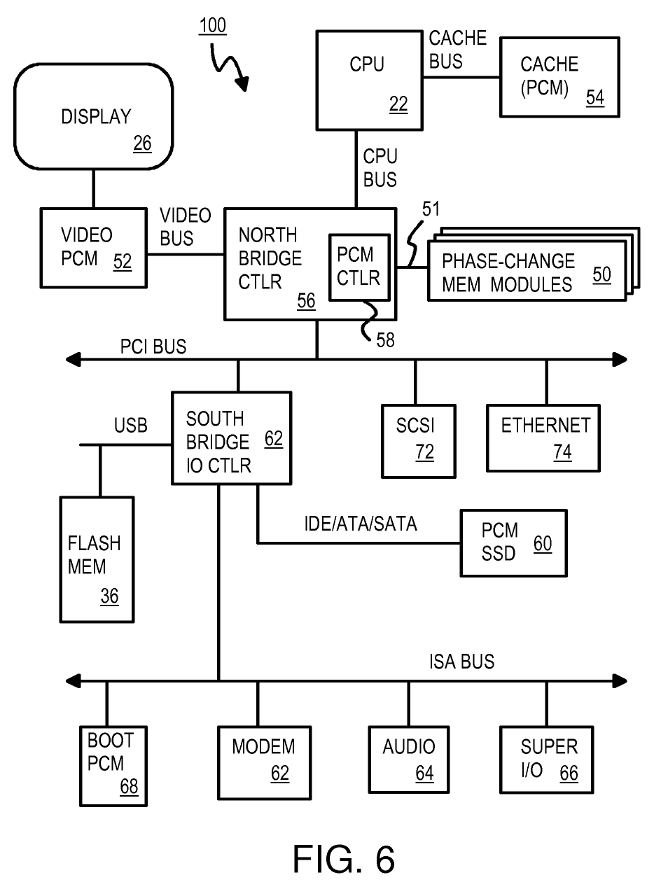

FIG. 6 shows more details of a fast resuming motherboard using phase-change memory. Motherboard 100 can be a main printed-circuit board (PCB) of a personal computer, although some components may be on daughter or add-on cards. For example, PCM memory modules 50 can be on small memory module cards that fit into memory module sockets on motherboard 100, while flash memory 36 may be a small portable device that fits into a USB receptacle. Modem 62 could be on motherboard 100 or on an add-on ISA or AT card, as could other components.

CPU 22 stores copies of data and instructions in cache 54. Cache 54 can be constructed from phase-change memory, or can be an SRAM cache. When cache 54 is integrated with CPU 22, cache 24 may be SRAM, depending on the microprocessor manufacturer. When cache 54 is PCM, faster resumes are possible since cache 54 does not have to be flushed and reloaded.

North bridge controller 56 is a chip or chip set that connects the various local buses together, such as the CPU bus from CPU 22, a video bus to video PCM memory 52, and memory bus 51 to PCM memory modules 50. PCM memory controller 58 in north bridge controller 56 can generate the timings and voltages for read, reset, and set of memory cells in PCM memory modules 50, or these functions may be integrated onto the PCM memory chips on PCM memory modules 50. PCM memory controller 58 could also be placed on each PCM memory modules 50, or the memory controller function could be partitioned between the PCM memory chips, memory modules, and north bridge controller 56.

North bridge controller 56 may include a direct-memory access (DMA) engine that allows for memory transfers that do not require reads and writes by CPU 22. For example, frame buffer data could be copied from PCM memory modules 50 directly to video PCM memory 52, or data from peripheral devices such as Ethernet card 74 or SCSI device 72 could be transferred directly to and from PCM memory modules 50.

North bridge controller 56 connects to Peripheral Component Interconnect (PCI) bus, which has a few higher-performance peripherals such as Ethernet card 74 and small-computer system interface (SCSI) device 72. SCSI device 72 could be a hard disk drive.

South bridge controller 62 connects to the PCI bus and transfers data to slower buses, such as to USB, integrated device electronics (IDE), Serial AT-Attachment (SATA), ATA, or Industry Standard Architecture (ISA) buses. Some devices on these buses may be removable, and some newer devices may use phase-change memory rather than older flash or DRAM memory. For example, PCM solid-state disk 60 may be a mass storage, block-addressable device that uses phase-change memory rather than flash memory or a rotating hard disk. Boot code may be stored in boot PCM 68, rather than in boot ROM 38 (FIG. 5).

Older and slower peripherals can be placed on the ISA bus and accessed by CPU 22 or DMA through north bridge controller 56 and south bridge controller 62. Modem 62, audio system 64, and super I/O 66 are examples of older peripherals that could be located on separate ISA cards that are removable, or could be integrated onto motherboard 100. An integrated I/O controller chip could include all these functions and be directly soldered onto motherboard 100.

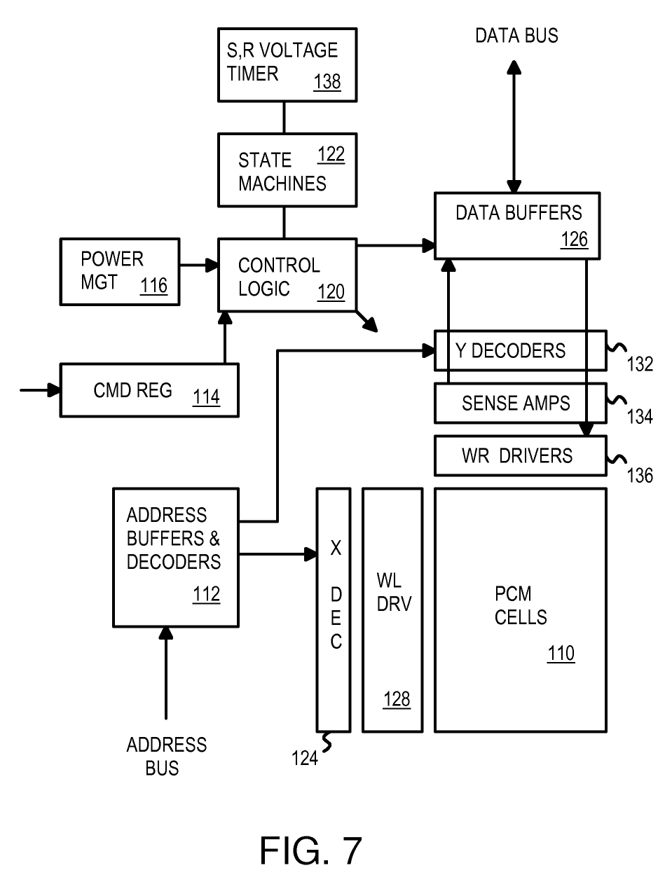

FIG. 7 shows a phase-change memory. A PCM chip may include some or all of the blocks shown in FIG. 7, and other blocks, or some of the functions may be performed by a separate PCM controller.

PCM cells 110 is an array of rows and columns of select transistors and alloy resistors that change between crystalline and amorphous phase states. The high and low resistance values of the 2 phase states are sensed by sense amplifiers 134 when a read current is drawn through a selected row of PCM cells. Word line drivers 128 drives one row or word line in PCM cells 110 while the other rows are disabled. A row portion of an address applied to address decoder 112 is further decoded by X decoder 124 to select which row to activate using word line drivers 128.

A column portion of the address applied to address decoder 112 is further decoded by Y decoder 132 to select a group of bit lines for data access. Data buffers 126 may be a limited width, such as 64 bits, while PCM cells may have a larger number of bit lines, such as 8×64 columns. One of the 8 columns may be selected by Y decoder 132 for connection to data buffers 126.

During writing, external data is collected by data buffers 126 and applied to write drivers 136. Write drivers 136 generate voltages or currents so that the set currents are applied to bit lines for PCM cells that are to be written with a 1, while higher reset currents are applied to bit lines for PCM cells to be reset to 0.

Set, reset voltage timer 138 includes timers that ensure that the set currents are applied by write drivers 136 for the longer set period of time, while the reset currents are applied for the shorter reset time period, and write drivers 136 for reset PCM cells are disabled after the reset time period.

State machines 122 can activate set, reset voltage timers 138 and cause control logic 120 to disable write drivers 136 after the set and reset time periods have expired. State machines 122 can generate various internal control signals at appropriate times, such as strobes to pre-charge bit lines and latch sensed data into data buffers 126.

Command register 114 can receive commands that are decoded and processed by control logic 120. External control signals such as read/write, data strobes, and byte enables may also be received in some embodiments. Command register 114 may be replaced by a command decoder in some embodiments. Power management unit 116 can power down blocks to reduce power consumption, such as when the PCM chip is de-selected. Since PCM cells 110 are non-volatile, data is retained when power is disconnected.

There may be several arrays of PCM cells 110 and associated logic on a large PCM chip. An array-select portion of the address can be decoded by address decoders 112 to enable one of the many arrays or blocks on the PCM chip.

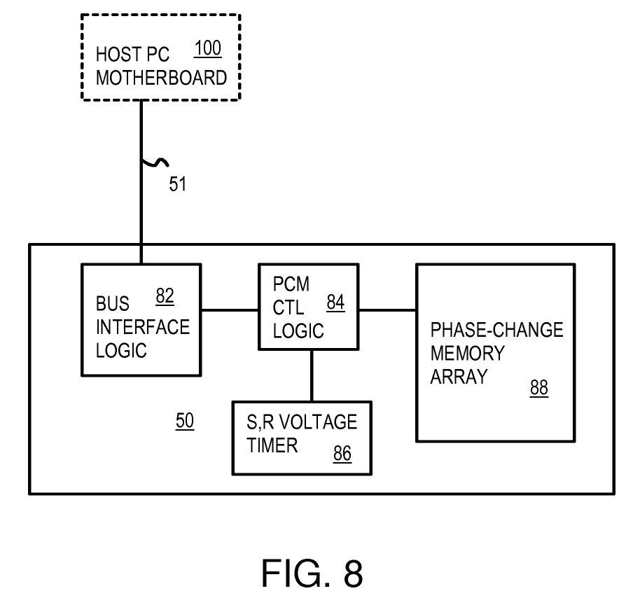

FIG. 8 shows a phase-change memory module. PCM memory module 50 can replace a standard DRAM memory module in some embodiments, but may require different applied voltages and differing control signals and timings than standard DRAM modules.

PCM array 88 may be one or more PCM chips each with blocks such as shown in FIG. 7. Data is stored in non-volatile phase-change memory cells, so data is retained when power is lost. PCM control logic 84 translates DRAM-type signals into PCM-type signals that can interface with PCM array 88. Set, reset voltage timer 86 generates voltages applied to PCM array 88 for generating set and reset currents when PCM array 88 does not contain internal set, reset timers and voltage generators. Set, reset voltage timer 86 can also include timers to generate pulse widths that are needed for set and reset write operations.

Bus interface logic 82 sends and receives signals from motherboard 100 over memory bus 51. For example, motherboard 100 may send data to PCM memory module 50 as serial-bus packets rather than as individual addresses and data. Bus interface logic 82 can parse these packets and generate PCM-specific control signals, and reformat address and data for use by PCM array 88.

PCM memory module 50 may be a fully-buffered memory module that has multiple bus connections to upstream and downstream memory modules. For example, northbound lanes of several serial lines in parallel may carry differential data upstream to the north bridge controller, or to an intervening memory module that forwards the data upstream to the north bridge controller. Southbound lanes may carry data away from the CPU and its north bridge controller to a daisy chain of downstream memory modules.

### Alternate Embodiments

Several other embodiments are contemplated by the inventors. For example the motherboard may have the video memory installed, or the video memory may be on an add-on video controller card, or the video memory may be a portion of the main memory, either installed directly on the motherboard or in memory modules. The video memory could be integrated in a video display controller as part of a high-integration SoC (System on a Chip). Some of the memories may be older SRAM or DRAM while other memories are PCM. The OS image is held in PCM to increase suspend/resume performance. A physical memory can be partitioned into several smaller memory units, such as for video and audio buffers, user, application, and operating system spaces.

While a personal computer (PC) has been described, other kinds of computers could benefit from fast suspend-resume using PCM. For example, laptop, Apple Mac's, Linux, Unix, and other kinds of computers, and portable devices, such as an ultra-mobile personal computer, mobile Internet devices, personal digital assistants (PDAs), smart phones, cell phone handsets, gaming devices, and game consoles could be the computer that uses the invention.

The PCM cells can use select transistors in series with the variable resistor as shown, or additional transistors may be added, such as for a dual-port memory with 2 bit lines per cell, and two select transistors that connect to the same alloy resistor. The melting and crystalline temperatures may vary with the alloy composition and with other factors such as impurities. The shape and size of the alloy resistor may also affect these temperatures and set, reset time periods.

The terms set and reset can be applied to either binary logic state. For example, set can refer to changing to the logic 1 state for positive logic, or to changing to the logic 0 state for negative or inverse logic. Likewise, reset is to 0 for positive logic, but inverted logic can reset to 1, such as for active-low logic. One system can use both active-high and active-low logic domains, and logic can refer to the physical states of the memory cells, or the data read at the I/O of a memory chip, or at some other point.

Directional terms such as upper, lower, up, down, top, bottom, etc. are relative and changeable as devices are rotated, flipped over, etc. These terms are useful for describing the device but are not intended to be absolutes. Some embodiments may have chips or other components mounted on only one side of a circuit board, while other embodiments may have components mounted on both sides.

Rather than mount packaged IC's onto one or more sides of the motherboard, unpackaged die may be mounted using die-bonding techniques. Using unpackaged die rather than packaged die may reduce the size and weight of the card. The edges of the motherboard could be straight or could be rounded or have some other shape.

Rather than use USB buses, other serial buses may be used such as PCI Express, ExpressCard, Firewire (IEEE 1394), serial ATA, serial attached small-computer system interface (SCSI), etc. For example, when PCI Express is used, additional pins for the PCI Express interface can be added or substituted for the USB differential data pins. PCI express pins include a transmit differential pair PET+, PET−, and a receive differential pair PER+, PER− of data pins. A multi-bus-protocol chip could have an additional personality pin to select which serial-bus interface to use, or could have programmable registers. ExpressCard has both the USB and the PCI Express bus, so either or both buses could be present on an ExpressCard device.

The microcontroller components such as the serial engine, DMA, PCM memory controller, transaction manager, and other controllers and functions can be implemented in a variety of ways. Functions can be programmed and executed by the CPU or other processor, or can be implemented in dedicated hardware, firmware, or in some combination. Many partitioning of the functions can be substituted.

A standard flash, DRAM, or SRAM controller may be integrated with the PCM controller to allow for accessing these various kinds of memories. Suspend and resume routines may contain instructions that are part of the operating system, basic input-output system (BIOS), manufacturer-specific routines, and higher-level application programs, and various combinations thereof. Various modified bus architectures may be used. Buses such as the local bus may have several segments isolated by buffers or other chips.

The phase-change memory has been described as having cells that each store one binary bit of data. However, multi-level cells are contemplated wherein multiple logic levels are defined for different values of resistance of the alloy resistor.

Any advantages and benefits described may not apply to all embodiments of the invention. When the word “means” is recited in a claim element, Applicant intends for the claim element to fall under 35 USC Sect. 112, paragraph 6. Often a label of one or more words precedes the word “means”. The word or words preceding the word “means” is a label intended to ease referencing of claim elements and is not intended to convey a structural limitation. Such means-plus-function claims are intended to cover not only the structures described herein for performing the function and their structural equivalents, but also equivalent structures. For example, although a nail and a screw have different structures, they are equivalent structures since they both perform the function of fastening. Claims that do not use the word “means” are not intended to fall under 35 USC Sect. 112, paragraph 6. Signals are typically electronic signals, but may be optical signals such as can be carried over a fiber optic line.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

We claim:

1. A phase-change-memory (PCM) motherboard comprising:
a main memory storing instructions and data in a phase-change memory, wherein the instructions and data are retained when power is removed from the main memory, the phase-change memory comprising a plurality of PCM cells each having a first logical state having an alloy in a crystalline phase and a second logical state having the alloy in an amorphous phase, wherein a resistance of the alloy is higher when in the amorphous phase than when in the crystalline phase;
a processor, coupled to the main memory, for fetching and executing the instructions from the main memory and for writing the data to the main memory;
a video memory, coupled to be written by the processor, for storing a frame buffer of pixels updated by the processor, the frame buffer containing pixel data to generate a visible display to a user;
a cache memory, coupled to the processor, for storing rapidly-accessible copies of instructions and data from the main memory;
a mass storage device for storing blocks of instructions and blocks of data, the mass storage device being block-addressable wherein individual instructions are not separately accessible from other instructions in a block of instructions;
an I/O coprocessor, coupled between the mass storage device and the main memory, for reading blocks of data and blocks of instructions from the mass storage device and writing the blocks of data and blocks of instructions to the main memory;
an operating system image stored in the phase-change memory of the main memory, the operating system image containing instructions and system parameters for an operating system that controls the processor during normal operation by the user;
a suspend/resume routine, stored as instructions in the phase-change memory of the main memory, the suspend/resume routine being executed by the processor immediately before power is removed from the main memory when the user suspends operation, the suspend/resume routine also being executed by the processor immediately after power is re-applied to the main memory when the user resumes operation; and
a substrate for supporting and electrically connecting the main memory, the processor, the video memory, and I/O coprocessor,
whereby the suspend/resume routine is stored and executed from the phase-change memory in the main memory.

2. The PCM motherboard of claim 1 wherein the video memory comprises a phase-change memory of a plurality of the PCM cells, wherein the frame buffer is retained when power is removed from the video memory and is not re-generated by the processor when power is restored after a suspend/resume operation,
whereby the frame buffer is retained on suspend/resume.

3. The PCM motherboard of claim 2 wherein the video memory comprises a partition the phase-change memory in the main memory,
wherein the video memory and the main memory are partitions of a shared phase-change memory.

4. The PCM motherboard of claim 1 wherein the cache memory comprises a static random-access memory (SRAM);
wherein the suspend/resume routine further comprises a cache-disable instruction to disable the cache memory during suspend, a cache-flush instruction to delete instructions and data stored in the cache memory, and a cache-enable instruction to enable the cache memory to be reloaded from instructions and data read from the main memory during resume after the cache-flush instruction has been executed,
whereby the cache memory is flushed and reloaded for suspend/resume, while the main memory retains instructions and data during suspend/resume.

5. The PCM motherboard of claim 1 wherein the cache memory comprises a phase-change memory comprising a plurality of the PCM cells;
wherein the cache memory retains copies of instructions and data when power is removed during suspend;
wherein the cache memory is not flushed for a suspend/resume.

6. The PCM motherboard of claim 1 further comprising:
a local bridge chip, coupled between the processor and the main memory, for fetching instructions from the main memory over a memory bus and for sending fetched instructions to the processor over a processor bus,
whereby the processor and the main memory are coupled together by the local bridge chip.

7. The PCM motherboard of claim 6 wherein the processor directly accesses individual instructions and data in the main memory,
wherein the phase-change memory is randomly addressable.

8. The PCM motherboard of claim 1 wherein a PCM cell in the plurality of PCM cells comprises:
a select transistor receiving a word line on a gate, and having a channel between a bit line and a cell node;
an alloy resistor formed from the alloy, coupled between the cell node and an array voltage;
wherein the PCM cell has the first logical state when the alloy resistor has the alloy in the crystalline phase, the alloy resistor having a low resistance that increases a sensing current from the bit line through the select transistor;
wherein the PCM cell has the second logical state when the alloy resistor has the alloy in the amorphous phase, the alloy resistor having a high resistance that reduces the sensing current from the bit line through the select transistor;
wherein the high resistance is larger than the low resistance;
whereby the sensing current is altered by the alloy being in the crystalline phase and the amorphous phase.

9. The PCM motherboard of claim 8 wherein the phase-change memory further comprises:
a set current generator, coupled to the bit line, for driving a set current through the select transistor and through the alloy resistor for a set period of time to write the PCM cell into the first logical state in response to a write data input in the first logical state;
a reset current generator, coupled to the bit line, for driving a reset current through the select transistor and through the alloy resistor for a reset period of time to write the PCM cell into the second logical state in response to the write data input in the second logical state;
a reset timer for determining the reset period of time; and
a set timer for determining the set period of time;
wherein the reset current is at least twice the set current, and wherein the set current is at least twice the sensing current;
wherein the set period of time is at least double the reset period of time,
whereby the PCM cell is set by a lower current for a longer time period, and reset by a higher current and a shorter time period.

10. The PCM motherboard of claim 9 wherein the alloy is a chalcogenide glass layer having a melting point that is higher than a crystallization point.

11. The PCM motherboard of claim 10 wherein the alloy is an alloy of germanium (Ge), antimony (Sb), and tellurium (Te).

12. A non-volatile computer comprising:
processor means for fetching and executing instructions and for writing data;
phase-change memory means for storing instructions and data as binary bits each represented by a chalcogenide glass layer having a melting point that is higher than a crystallization point, the chalcogenide glass layer forming a variable resistor that alters a sensing current when a binary bit is read;
wherein a crystalline state of the variable resistor represents a first binary logic state and an amorphous state of the variable resistor represents a second binary logic state for binary bits stored in the phase-change memory means;
local bus controller means for receiving addresses from the processor means and fetching instructions from the phase-change memory means stored at the addresses from the processor means, and for transferring data to and from the phase-change memory means and the processor means in response to data addresses from the processor means;
set current timer means, coupled to the phase-change memory means, for generating a set current for a set period of time to set variable resistors into the crystalline state when the binary bits being written are in the first binary logic state;
reset current timer means, coupled to the phase-change memory means, for generating a reset current for a reset period of time to reset variable resistors into the amorphous state when the binary bits being written are in the second binary logic state;
wherein the reset current is at least twice the set current, and wherein the set current is at least twice a sensing current that passes through the variable resistor during a read operation;
wherein the set period of time is at least double the reset period of time,
whereby the variable resistor is set by a lower current for a longer time period, and reset by a higher current and a shorter time period.

13. The non-volatile computer of claim 12 further comprising:
video phase-change memory means for storing a frame buffer of pixels for display by a display, wherein pixels are comprised of binary bits each represented by a chalcogenide glass layer having a melting point that is higher than a crystallization point, the chalcogenide glass layer forming a variable resistor that alters a sensing current when a binary bit is read;
wherein a crystalline state of the variable resistor represents a first binary logic state and an amorphous state of the variable resistor represents a second binary logic state for binary bits stored in the phase-change memory means;
wherein the local bus controller means is further for writing pixels generated by the processor means to the video phase-change memory means,
whereby frame-buffer pixels are stored in phase-change memory.

14. The non-volatile computer of claim 13 wherein the frame buffer of pixels stored in the video phase-change memory means is retained when power is suspended and the non-volatile computer enters a suspended mode;
wherein the instructions and data stored in the phase-change memory means is retained when power is suspended and the non-volatile computer enters the suspended mode,
whereby the frame buffer of pixels and instructions are stored in non-volatile memory.

15. The non-volatile computer of claim 12 further comprising: local operating system image means for storing a current operating state of the non-volatile computer, the local operating system image means stored in the phase-change memory means;
wherein the local operating system image means is retained when power is suspended and the non-volatile computer enters a suspended mode;
resume means, executed by the processor means when power is re-applied after the suspended mode, for executing instructions read from the local operating system image means that are read from the phase-change memory means;
wherein the processor means resumes operation by executing instructions from the phase-change memory means;
whereby the local operating system image means in the phase-change memory means is retained and executed after suspend.

16. The non-volatile computer of claim 15 further comprising:
peripheral bus controller means, coupled to the local bus controller means, for coupling the local bus controller means to peripheral devices on peripheral buses;
mass storage means, coupled to the peripheral bus controller means, for storing addressable blocks, wherein addressable blocks comprise blocks of instructions and data that are not individually addressable by the processor means and are block-addressable;
peripheral operating system image means for storing a copy of the current operating state of the non-volatile computer, the peripheral operating system image means stored in the mass storage means;
wherein the processor means resumes operation without copying the peripheral operating system image means from the mass storage means,
whereby the local operating system image means in the phase-change memory means is retained and executed after suspend without transferring the copy of the current operating state from the mass storage means.

17. A phase-change-memory personal computer comprising:
a microprocessor for executing instructions and for writing data in a local memory space;
a phase-change memory in the local memory space that stores instructions and data that are directly accessible by the microprocessor;
an array of memory cells in the phase-change memory, each memory cell in the array of memory cells having an alloy resistor that stores binary data as solid phases each having a different resistivity;
wherein the alloy resistor changes from a crystalline state to an amorphous state when a memory cell is written from a logic 1 to a logic 0 in response to a reset current for a reset period of time;
wherein the alloy resistor changes from the amorphous state to the crystalline state when the memory cell is written from a logic 0 to a logic 1 in response to a set current for a set period of time;
wherein the amorphous state has a higher resistance than the crystalline state that is sensed by a sense amplifier;
a local bus controller for transferring instructions and data between the phase-change memory and the microprocessor;
a display buffer, coupled to receive pixel updates from the microprocessor through the local bus controller, the display buffer storing pixels in a phase-change memory formed from memory cells each having the alloy resistor;
a video controller for driving pixels from the display buffer to a display for viewing by a user,
whereby pixels and instructions are stored in phase-change memory.

18. The phase-change-memory personal computer of claim 17 further comprising:
a peripheral bus controller, coupled to the local bus controller, for accessing peripheral devices on peripheral buses;
a boot read-only-memory, coupled to the peripheral bus controller, for storing a boot routine of instructions that is executed by the microprocessor at initial power-on; and
a suspend/resume routine of instructions stored in the phase-change memory and directly executed by the microprocessor before suspending power and after resuming power after suspending power,
whereby the boot routine of instructions in the boot read-only-memory is executed by the microprocessor on initial power-on, and the suspend/resume routine of instructions read from the phase-change memory is executed for suspend/resume.

19. The phase-change-memory personal computer of claim 18 further comprising:
a mass storage device on a first intermediate bus situated between the peripheral bus controller and the local bus controller;
a network controller for connecting to a network, the network controller on the first intermediate bus;
wherein the peripheral devices comprise:
a flash memory device on a first peripheral bus coupled to the peripheral bus controller, for storing data in flash memory;
a boot read-only memory on a second peripheral bus coupled to the peripheral bus controller, for storing boot code for execution by the microprocessor upon power-on; and
an audio controller on the second peripheral bus coupled to the peripheral bus controller, for generating sounds audible to the user.

20. The phase-change-memory personal computer of claim 17 further comprising:
a reset timer for determining the reset period of time; and
a set timer for determining the set period of time;
wherein the reset current is at least twice the set current, and wherein the set current is at least twice a sensing current for reading;
wherein the set period of time is at least double the reset period of time,
whereby the alloy resistor in the memory cell is set by a lower current for a longer time period, and reset by a higher current and a shorter time period.
